(19) United States
(12) Patent Application Publication
(10) Pub. No.: US 2023/0036266 A1
(43) Pub. Date: Feb. 2, 2023

(54) CONTROLLING GASEOUS FUEL FLOW

(71) Applicant: Pratt & Whitney Canada Corp., Longueuil (CA)

(72) Inventors: Lu Xuening, Oakville (CA); Ezzat MeshkinFam, Mississauga (CA); Sean Durand, Brossard (CA)

(73) Assignee: Pratt & Whitney Canada Corp., Longueuil (CA)

(21) Appl. No.: 17/386,399

(22) Filed: Jul. 27, 2021

(51) Int. Cl. F02C 7/22; G05D 7/06

(52) U.S. Cl. CPC F02C 7/222; G05D 7/0635; G05D 7/0652; F05D 2220/323

(57) ABSTRACT

A fuel control system for an aircraft engine, comprises a fuel feed conduit including an inlet end and an outlet end. A fuel metering mechanism is disposed in the fuel feed conduit between the inlet end and the outlet end operable to regulate flow through the fuel feed conduit. A position feedback sensor is operatively connected to the fuel metering mechanism and operable to generate a signal indicative of a position of the fuel metering mechanism.

### TECHNICAL FIELD

There is an ongoing need for accurate control systems and methods for handling gaseous fuel like hydrogen over a range of operating conditions such as in aircraft operation.

### SUMMARY

A fuel control system for an aircraft engine, comprises a fuel feed conduit including an inlet end and an outlet end. A fuel metering mechanism is disposed in the fuel feed conduit between the inlet end and the outlet end operable to regulate flow through the fuel feed conduit. A position feedback sensor is operatively connected to the fuel metering mechanism and operable to generate a signal indicative of a position of the fuel metering mechanism. In certain embodiments, the fuel metering mechanism is or includes at least one metering valve.

A controller is operatively connected to the electronic metering valve and to the position feedback sensor and operable to control the position of the fuel metering mechanism based on the signal indicative of the position of the electronic fuel metering mechanism and a command for a desired power output of the aircraft engine to achieve the desired power output. In embodiments, a torque motor driver is operatively connected to drive the fuel metering mechanism upon receipt by the torque motor driver of a command signal from the controller to control the position of the fuel metering mechanism.

In embodiments, a fuel pressure sensor is operatively connected to the fuel feed conduit and operable to generate a signal indicative of a fuel pressure in the fuel feed conduit. In certain embodiments, the controller is operatively connected to the fuel pressure sensor and operable to receive the signal from the fuel pressure sensor. In certain such embodiments, the controller is operable to control the position of the fuel metering mechanism based on the signal indicative of the fuel pressure in the fuel feed conduit.

In embodiments, a temperature sensor is operatively connected to the fuel feed conduit and operable to generate a signal indicative of a fuel temperature in the fuel feed conduit. In certain embodiments, the controller is operable to control the position of the fuel metering mechanism based on the signal indicative of the fuel temperature in the fuel feed conduit.

In certain embodiments, the fuel pressure sensor is a first fuel pressure sensor and a second fuel pressure sensor is operatively connected to the feed conduit operable to generate a second signal indicative of a fuel pressure in the fuel feed conduit. In certain such embodiments, the controller is operatively connected to the second fuel pressure sensor and operable to receive the second signal from the second fuel pressure sensor such that the controller is operable to control the position of the fuel metering mechanism based on the second signal indicative of the fuel pressure in the fuel feed conduit.

In embodiments, a delta pressure sensor operatively connected to the fuel feed conduit and to a combustor operable to generate a signal indicative of a difference in pressure between the fuel feed conduit and the combustor. In certain embodiments, the delta pressure sensor is operatively connected to a delta pressure input of the controller, such that the controller is operable to control the position of the fuel metering mechanism based on the signal indicative of the difference in pressure between the fuel feed conduit and the combustor.

In certain embodiments, the first fuel pressure sensor is disposed in the fuel feed conduit upstream of the fuel metering mechanism, the second pressure sensor is disposed in the fuel feed conduit downstream of the fuel metering mechanism and upstream of the combustor, and a third pressure sensor is connected to the delta pressure sensor such that the third pressure sensor is operable to communicate a pressure of the combustor to the delta pressure sensor. In certain such embodiments, the delta pressure sensor operatively connects to the feed conduit via a delta pressure sensor line separate from a second pressure sensor input line of the second fuel pressure sensor.

In embodiments, each of the signal indicative of a fuel pressure in the fuel feed conduit, the signal indicative of a fuel temperature in the fuel feed conduit, the second signal indicative of a fuel pressure in the fuel feed conduit, and the signal indicative of the difference in pressure between the fuel feed conduit and the combustor comprise a plurality inputs to a control algorithm executable at least in part by the controller to generate a fuel metering mechanism control signal as an output based on the plurality of inputs, wherein the controller is operable to control the fuel metering mechanism by sending the fuel metering mechanism signal to the fuel metering mechanism.

In embodiments, a flow divider assembly is fluidly connected to the outlet end of the fuel feed conduit to divide and issue flow from the fuel feed conduit into a first fuel manifold and a second fuel manifold, the first and second fuel manifolds being fluidly connected to issue fuel to a respective plurality of fuel nozzles. In certain embodiments, a first controlled flow valve is disposed in the first fuel manifold, and a second controlled flow valve is disposed in the second fuel manifold. In certain such embodiments, the first and second controlled flow valves can be solenoid valves operatively connected to the controller to selectively energize and de-energize the first and second flow valves to selectively allow flow through the first and second manifolds. In certain such embodiments, the first and second controlled flow valves can be electrohydraulic servo valves operatively connected to the controller to selectively control the first and second flow valves to selectively allow flow through the first and second manifolds.

In embodiments, a gaseous pressure and/or temperature regulated fuel supply is fluidly connected to the inlet end of the fuel feed conduit. A first plurality of gaseous hydrogen fuel nozzles is fluidly connected to the outlet end of the fuel feed conduit via a first fuel manifold. A second plurality of gaseous hydrogen fuel nozzles is fluidly connected to the outlet end of the fuel feed conduit via the second fuel manifold.

In embodiments, the system comprises a combustor, a compressor section fluidly connected to an inlet of the combustor; and a turbine section fluidly connected to an outlet of the combustor. The first and second pluralities of fuel nozzles are fluidly connected to the combustor and wherein the turbine section is operatively connected to the compressor section and operable to drive the compressor section.

In accordance with another aspect of this disclosure, there is provided a method for controlling fuel flow in an aircraft engine. The method includes determining an energized status of a flow valve in a fuel manifold, determining if flow in the feed conduit is sonic, calculating an effective area of an electronic fuel metering valve using a signal indicative of a position of the electronic metering valve from a position feedback sensor, calculating a required fuel flow for a desired power output, adjusting the position of the electronic fuel metering valve and/or the energized status of the flow valve to achieve the required fuel flow based on the signal indicative of the position of the electronic metering valve and a command for a desired output power to achieve the desired power output.

In embodiments, if a first controlled flow valve and second controlled flow valve are both de-energized to prevent flow, the method includes controlling a flow rate through the electronic metering valve to achieve zero pounds per hour fuel flow through the electronic metering valve.

In embodiments, if the first controlled flow valve is energized to allow flow and the flow through the feed conduit is sonic, the method includes calculating a sonic flow rate as a function of a first fuel pressure in the fuel feed conduit upstream of the electronic metering valve and a first fuel temperature in the fuel feed conduit upstream of the electronic metering valve. In all other instances, if the flow through the fuel feed conduit is sub-sonic, the method includes calculating a subsonic flow rate as a function of the first fuel pressure, the first fuel temperature, a second fuel pressure in the feed conduit downstream of the electronic metering valve, and a pressure differential between the second fuel pressure and a pressure in a combustor of the aircraft engine.

In embodiments, the method includes, after calculating the supersonic flow rate or subsonic flow rate, checking an energized/de-energized status of the first controlled flow valve and of the second controlled flow valve and determining whether the flow through the fuel feed conduit is sonic repeating the steps of the method described above.

In embodiments, the method includes calculating a ratio of the second fuel pressure to the first fuel pressure, and determining the flow in the fuel feed conduit is sonic if the ratio is less than 0.5283 and is subsonic if the ratio is greater than or equal to 0.5283.

In accordance with yet another aspect of this disclosure, there is provided an electronic controlled aircraft fuel system. The system includes a gas turbine engine having a compressor section, combustor section in fluid communication with an outlet of the compressor section, and a turbine section in fluid communication with an outlet of the combustor. The turbine section is operatively connected to drive the compressor section. The combustor includes a plurality of fuel nozzles each fluidly connected via a fuel feed conduit to feed the plurality of fuel nozzles of the combustor with a gaseous fuel supply.

In embodiments, the system includes means for regulating flow through the fuel feed conduit, means for generating a signal indicative of a state of the means for regulating, and an electronic engine control (EEC) module. The EEC module operatively connected to the means for regulating and to the means for generating a signal to control the means for regulating a signal based on the signal such that the EEC module controls a state of the means for regulating to achieve a desired power output.

These and other features of the embodiments of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is schematic cross-sectional side elevation view an aircraft engine in accordance with this disclosure, showing a plurality of fuel components connecting a fuel source to a combustor;

FIG. 2 is a schematic view of an embodiment of a fuel control system for the engine of FIG. 1 constructed in accordance with at least one aspect of this disclosure; and

FIG. 3 is a schematic flow diagram of a method of operating the control system of FIG. 2 constructed in accordance with at least one aspect of this disclosure.

### DETAILED DESCRIPTION

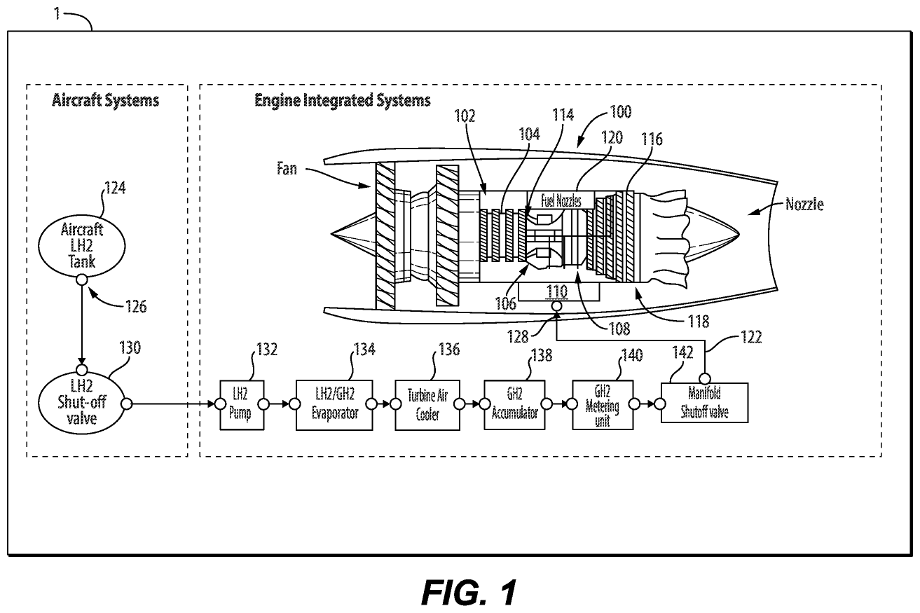

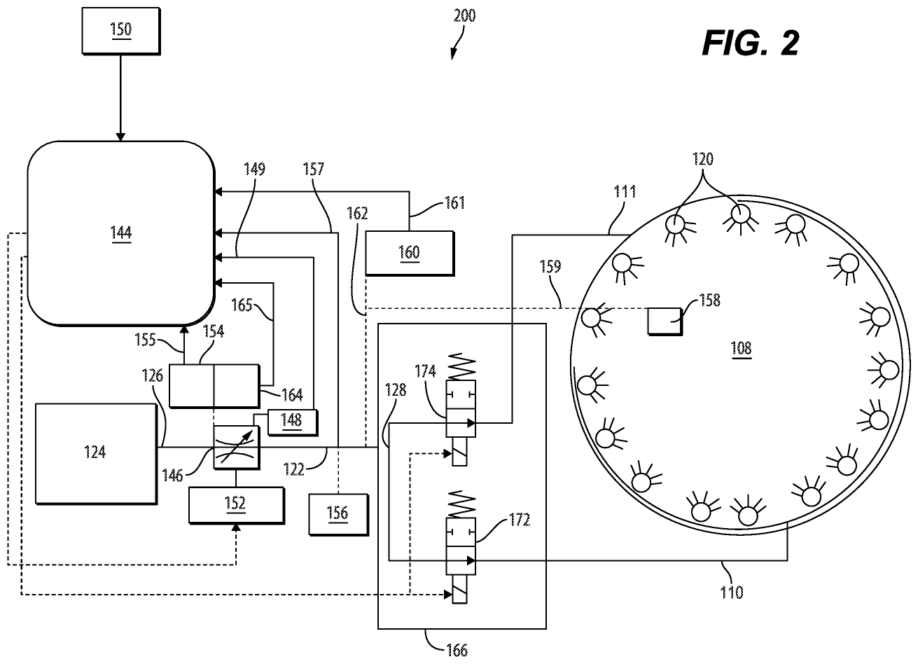

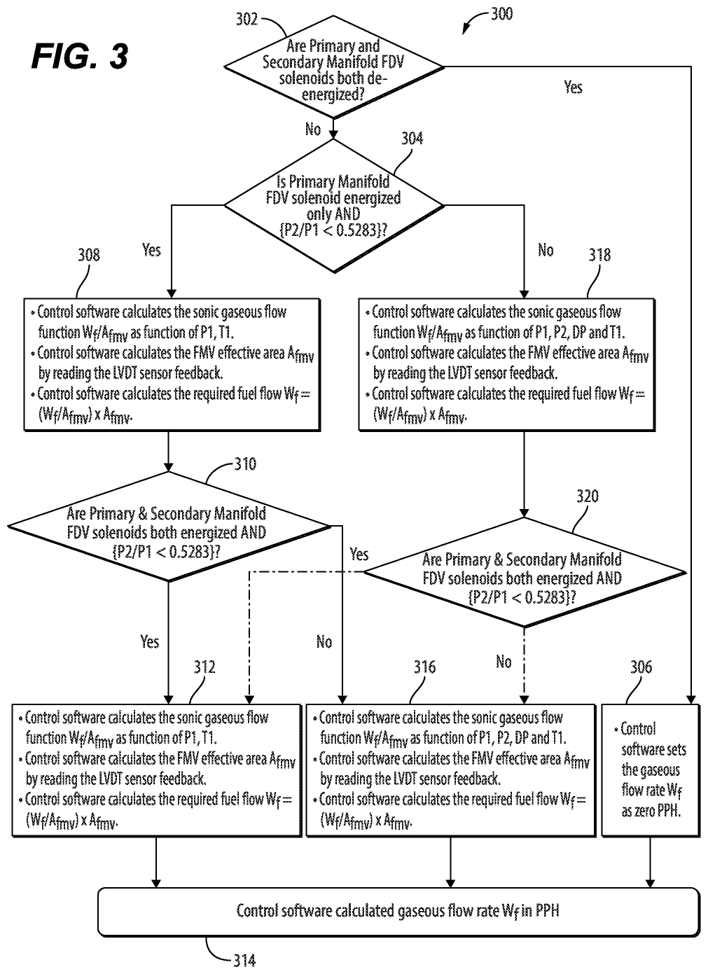

Reference will now be made to the drawings wherein like reference numerals identify similar structural features or aspects of the subject disclosure. For purposes of explanation and illustration, and not limitation, an illustrative view of an embodiment of a system in accordance with the disclosure is shown in FIG. 1 and is designated generally by reference character 100. Other embodiments and/or aspects of this disclosure are shown in FIGS. 2-3. Certain embodiments described herein can be used to improve fuel metering for gaseous fuel, e.g. compressible fuels such as hydrogen gas.

The present disclosure relates generally to fuel control for gas turbine engines, and more particularly to control of gaseous fuel flow. A gas turbine engine may be fueled with gaseous fuel such as hydrogen gas. It is possible to gasify liquid hydrogen from an aircraft supply through an appropriate fuel pump, heat exchangers, pressure regulator, and metering valves. It is desired to control gaseous fuel delivery to the engine such that stable and responsive control over the wide range of flow conditions would be maintained. However, the traditional fuel control for aircraft engines are designed for purely liquid fuel flow. Liquid fuel is an incompressible fluid, whereas gaseous fuel is compressible. For hydrogen, the full fuel system can include a combination of liquid and gaseous hydrogen, meaning the fuel control system needs to control both compressible and incompressible flows.

The gaseous hydrogen is pressurized from the fuel delivering system so that pressure supplied to the fuel line P1 is regulated at a much higher pressure of the burner pressure P3 (e.g. at least double). Therefore, variation of fuel metering valve output sets a variable throat area to the valve which is maintained choked (e.g. in a sonic state) at all system flow conditions.

In certain embodiments, referring to FIG. 1, an aircraft 1 can include an engine 100, where the engine 100 can be a propulsive energy engine (e.g. creating thrust for the aircraft 1), or a non-propulsive energy engine, and a fuel system. As described herein, the engine 100 is a turbofan engine, although the present disclosure may likewise be used with other engine types. The engine 100 includes a compressor section 102 having a compressor 104 in a primary gas path 106 to supply compressed air to a combustor 108 of the aircraft engine 100. The primary gas path 106 includes a nozzle manifold 110 for issuing fluid to the combustor 108.

The primary gas path 106 includes, in fluid communication in a series: the compressor 104, the combustor 108 fluidly connected to an outlet 114 of the compressor 104, and a turbine section 116 fluidly connected to an outlet 118 of the combustor 108. The turbine section 116 is mechanically connected to the compressor 104 to drive the compressor 104.

The combustor 108 includes a plurality of fuel nozzles 120 each fluidly connected via a fuel feed conduit 122, which feeds the nozzle manifold 110, which feeds the plurality of fuel nozzles 120 of the combustor 108 with a gaseous fuel supply 124. The feed conduit 122 includes an inlet end 126 and an outlet end 128 to fluidly connect the gaseous fuel supply 124 to the combustor 108 through the plurality of fuel nozzles 120. In embodiments, the gaseous fuel supply 124 can be any suitable gaseous fuel, such as a gaseous pressure and/or temperature regulated fuel supply, which may be or include hydrogen gas.

Certain additional components may also be included in fluid communication between the combustor and the gaseous fuel supply 124 in any suitable order or combination, such as a fuel shut off valve 130, a fuel pump 132, a liquid/gaseous fuel evaporator 134, a turbine air cooling heat exchanger 136, a gaseous fuel accumulator 138, a gaseous fuel metering unit 140, and/or a fuel manifold shut off valve 142. In certain embodiments, the pre-pressurized gaseous fuel accumulator 138 can be used as backup supply pressure source.

Turning now to FIG. 2, a fuel control system 200 for controlling the flow of fuel to the aircraft engine 100 through the feed conduit 122 and the plurality of fuel nozzles 120 includes a means for regulating flow through the fuel feed conduit 122, means for generating a signal indicative of a state of the means for regulating, and a controller 144. The controller 144 can include any suitable controller, for example an electronic engine controller (EEC). The controller 144 is operatively connected to the means for regulating and to the means for generating a signal to control the means for regulating a signal based on the signal such that the controller is operable to control a state of the means for regulating to achieve a desired power output.

As described herein, the means for regulating flow through the fuel feed conduit 122 (e.g. fuel metering mechanism) can include any suitable means, for example can be or include at least one metering valve, an electronic metering valve 146, an electro-pneumatic metering valve, or a combination of valves and/or other devices. The means for generating a signal indicative of a state of the electronic metering valve 146 can include any suitable means, for example any number and/or combination of pressure and/or temperature sensors, position sensors, or the like, disposed in the engine 100 and operatively connected as disclosed herein.

As shown in FIG. 2, the electronic metering valve 146 is disposed in the fuel feed conduit 122 between the inlet end 126 and the outlet end 128 operable to regulate flow through the fuel feed conduit 122. A position feedback sensor 148 is operatively connected to the electronic metering valve 146 and operable to generate a signal 149 indicative of a position of the electronic metering valve 146. The position feedback sensor 148 can be or include any suitable position sensor, for example a linear variable differential transformer (LVDT).

The controller 144 is operatively connected to the electronic metering valve 146 and to the position feedback sensor 148 to control the position of the electronic metering valve 146 based on the signal 149 indicative of the position of the electronic metering valve 146 and a command power 150 for a desired power output of the aircraft engine 100 to achieve the desired power output, e.g. as simultaneous inputs. Upon receipt of a command power 150 to the controller 144, the position of the electronic metering valve 146 is ultimately driven by a torque motor driver 152 operatively connected to the electronic metering valve 146.

In addition to position feedback from the position feedback sensor 148, the controller 144 is configured to control the flow through the fuel nozzles 120 as a function of a plurality signals from a plurality of sensors within the engine 100. For example, three fuel pressure sensors 154, 156, 158 can be included. The first fuel pressure sensor 154 is operatively connected to the fuel feed conduit 122 upstream of the electronic metering valve 146 and operable to generate a signal 155 indicative of a fuel pressure (P1) in the fuel feed conduit 122 upstream of the electronic metering valve 146. The second fuel pressure sensor 156 is operatively connected to the fuel feed conduit 122 downstream of the first pressure sensor 154 to generate a signal 157 indicative of a fuel pressure (P2) in the fuel feed conduit 122 downstream of the electronic metering valve 146 and upstream of the combustor 108. The third pressure sensor 158, a delta pressure sensor, can be a differential pressure sensor connected to both a pressure tap 159 in the combustor 108 and to a pressure tap 162 in the fuel feed conduit 122 downstream of the electronic metering valve 146. The third pressure sensor 158, is operable to generate and communicate a signal to the controller 144 indicative of a differential pressure between the pressure P2 in the fuel feed conduit 122 and the pressure 159 (P3) of the combustor 108. The third pressure sensor 158 can be a differential pressure sensor connected to both pressure taps 162 and 159, or can be an electronic device that takes the difference between two separate pressure sensors in the positions indicated for P2 and P3, including a module of the controller 144 that simply takes the difference between the signals for P2 and P3.

The controller 144 therefore is operable to control the position of the electronic metering valve 146 based on the each of the signal indicative of an upstream pressure 155, the signal indicative of a downstream pressure 157, and the signal indicative of the difference in pressure 161 between the feed conduit 122 (downstream of the electronic metering valve 146) and the combustor 108.

In certain embodiments, a temperature sensor 164 is also operatively connected to the controller 144 such that the controller 144 is operable to control the position of the electronic metering valve 146 based on the signals as described above, in addition to a signal indicative of the fuel temperature 165 in upstream heat exchangers (e.g. 134) which regulate gas temperature at the inlet 126 of the electronic metering valve 146.

Each of the signals 149 indicative of a position of the electronic metering valve 146, the signal 155 indicative of a fuel pressure in the fuel feed conduit 122, the signal 165 indicative of a fuel temperature in the fuel feed conduit 122, the second signal 157 indicative of a fuel pressure in the fuel feed conduit 122, and the signal 159 indicative of the difference in pressure between the fuel feed conduit 122 and the combustor 108 can be input into a control algorithm executable at least in part by the controller 144 to generate a fuel metering control signal as an output based on the plurality of inputs, thus, the controller 144 is operable to control the electronic metering valve 146 by sending the fuel metering signal to the electronic metering valve 146. In embodiments, the algorithm could be constructed using the functionality as described above in addition to known general engineering principles as applied to the specific characteristics of each particular fuel system to which the technology of the present disclosure is applied.

In embodiments, a flow divider assembly 166 is fluidly connected to the outlet 128 end of the fuel feed conduit 122 to divide and issue flow from the fuel feed conduit 122 into the combustor 108 and to the plurality of fuel nozzles 120 through a first fuel manifold 110 and a second fuel manifold 111. The first fuel manifold 110 can be a primary fuel manifold configured to provide sufficient fuel during low fuel consumption such as during start up, and the second fuel manifold 111 can be a secondary fuel manifold configured to supplement the primary fuel manifold during high fuel consumption.

Fuel flow to the first and second fuel manifolds 110, 111 is controlled by a first controlled flow valve 172 is disposed in the first fuel manifold 110, and a second controlled flow valve 174 is disposed in the second fuel manifold 111. The first and second controlled flow valves 172, 174 can be any suitable controllable flow valve, such as solenoid valves operatively connected to the controller to selectively energize and de-energize the first and second flow valves 172, 174 to selectively allow flow through the first and second manifolds 110, 111 to the combustor 108. In certain embodiments, the first and second controlled flow valves 172, 174 can be electrohydraulic servo valves operatively connected to the controller 144. The energized state corresponds to an open position, where the first and second fuel manifolds 110, 111 are able to issue fuel to the fuel nozzles 120 and the combustor 108 under given engine combustion configurations, and the de-energized state corresponds to a closed position, where the first and second fuel manifolds 110, 111 are prevented from issuing fuel to the fuel nozzles 120 and combustor 108 and fuel flow is cutoff. The controller 144 can control the flow through the first and second fuel manifolds 110, 111 through the first and second controlled flow valves 172, 174 using a method as described below, for example.

As shown in FIG. 3, there is provided an embodiment of a method 300 for controlling fuel flow in the aircraft engine 100. The method 300 includes determining 302 an energized status of the controlled flow valve 172, 174 in the fuel feed conduit 122 and determining 304 whether flow in the fuel feed conduit is subsonic or supersonic. Determining 304 if the flow in the feed conduit is subsonic or supersonic includes calculating a ratio of a second fuel pressure (P2) (e.g. from the signal 157 from the second fuel pressure sensor 156) to a first fuel pressure (P1) (e.g. from the signal 155 from the first fuel pressure sensor 154). If the ratio of second pressure to first pressure (P2/P1) is less than 0.5283, the fuel flow is considered sonic, while if the ratio is greater than or equal to 0.5283, the fuel flow is considered subsonic.

If the both the first controlled flow valve 172 and second controlled flow valve 174 are de-energized to prevent flow, the method includes controlling 306 a flow rate through the electronic metering valve to achieve zero pounds per hour fuel flow through the electronic metering valve 146, i.e. stopping fuel flow through the electronic metering valve 146.

If only the first controlled flow valve 172 is energized to allow flow to the first fuel manifold 110 and the flow through the fuel feed conduit 122 is supersonic, the method includes calculating 308 a sonic flow rate (W_{f}/A_{fmv}) as a function of the first fuel pressure (P1) in the fuel feed conduit 122 upstream of the electronic metering valve 146 and the fuel temperature (T1) in the fuel feed conduit 122 upstream of the electronic metering valve 146, where fmv effective area Afmv is a calculated by reading the position sensor feedback signal 149. Required fuel flow is then calculated using W_{f}=(W_{f}/A_{fmv})×A_{fmv}.

The method 300 includes rechecking 310 the energized status of the controlled flow valves 172, 174 and the sonic status of the fuel flow in the fuel feed conduit 122. If both the first and second controlled flow valves 172, 174 are energized, and the flow in the fuel feed conduit 122 is still sonic, the method includes recalculating 312 the sonic flow rate, the effective area, and the required fuel flow as described above with respect to 310. The calculated gaseous fuel flow rate 314 is then outputted to the controller 144 to control the electronic metering valve 146 to control flow in the fuel feed conduit 122 and to the first and second fuel manifolds 110, 111 to achieve the desired gaseous fuel flow rate for the given desired power. If, after the recheck 310, either of the first or second controlled flow valves 171, 174 are not energized, or the flow in the fuel feed conduit 122 is now subsonic, the method 300 includes calculating 316 a subsonic required fuel flow rate as described below and outputting the calculated gaseous fuel flow rate 314 to the controller 144.

If after the initial check 302, both the first and second controlled fuel valves 172, 174 are energized, or the fuel flow in the fuel feed conduit is subsonic, the method 300 includes calculating 318 a subsonic flow rate (W_{f}/A_{fmv}) as a function of the first fuel pressure (P1) in the fuel feed conduit 122 upstream of the electronic metering valve 146, the second fuel pressure (P2) in the fuel feed conduit 122 downstream of the electronic metering valve 146, the delta pressure 161 (e.g. the difference in pressure between the combustor pressure P3 and the second fuel pressure P2), and the first fuel temperature (T1) in the fuel feed conduit 122 upstream of the electronic metering valve 146, where fmv effective area Afmv is a calculated by reading the position sensor feedback 149. Required fuel flow is then calculated using W_{f}=(W_{f}/A_{fmv})×A_{fmv}.

The method 300 then includes rechecking 320 the energized status of the controlled flow valves 172, 174 and the sonic status of the fuel flow in the fuel feed conduit 122. If either of the first and second controlled flow valves 172, 174 are de-energized and the fuel flow in the fuel feed conduit is subsonic, the method 300 includes recalculating the subsonic required fuel flow rate as described above with respect to calculating 316. The calculated gaseous fuel flow rate 314 is then outputted to the controller 144 to control the electronic metering valve 146 to control flow in the fuel feed conduit 122 and to the first and second fuel manifolds 110, 111 to achieve the desired gaseous fuel flow rate for the given desired power. If at the recheck 320 both the first and second controlled flow valves 172, 174 are energized and the flow rate is now sonic, the method includes calculating the sonic required fuel flow rate as described above with respect to calculating 312, and outputting the calculated gaseous fuel flow rate 314 to the controller 144.

The method as described herein can be repeated as many times as needed or desired, or may run continuously while fuel is consumed.

As will be appreciated by those skilled in the art, aspects of the present disclosure may be embodied as a system, method or computer program product. Accordingly, aspects of this disclosure may take the form of an entirely hardware embodiment, an entirely software embodiment (including firmware, resident software, micro-code, etc.), or an embodiment combining software and hardware aspects, all possibilities of which can be referred to herein as a “circuit,” “module,” or “system.” A “circuit,” “module,” or “system” can include one or more portions of one or more separate physical hardware and/or software components that can together perform the disclosed function of the “circuit,” “module,” or “system”, or a “circuit,” “module,” or “system” can be a single self-contained unit (e.g., of hardware and/or software). Furthermore, aspects of this disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of this disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of this disclosure may be described above with reference to flowchart illustrations and/or block diagrams of methods, apparatus (systems) and computer program products according to embodiments of this disclosure. It will be understood that each block of any flowchart illustrations and/or block diagrams, and combinations of blocks in any flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in any flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified herein.

Those having ordinary skill in the art understand that any numerical values disclosed herein can be exact values or can be values within a range. Further, any terms of approximation (e.g., “about”, “approximately”, “around”) used in this disclosure can mean the stated value within a range. For example, in certain embodiments, the range can be within (plus or minus) 20%, or within 10%, or within 5%, or within 2%, or within any other suitable percentage or number as appreciated by those having ordinary skill in the art (e.g., for known tolerance limits or error ranges).

The articles “a”, “an”, and “the” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

Any suitable combination(s) of any disclosed embodiments and/or any suitable portion(s) thereof are contemplated herein as appreciated by those having ordinary skill in the art in view of this disclosure.

The embodiments of the present disclosure, as described above and shown in the drawings, provide for improvement in the art to which they pertain. While the apparatus and methods of the subject disclosure have been shown and described, those skilled in the art will readily appreciate that changes and/or modifications may be made thereto without departing from the scope of the subject disclosure.

For example, the following particular embodiments of the present technology are likewise contemplated, as described herein next by clauses.

Clause 1. A fuel control system (200) for an aircraft engine (100), comprising:

a fuel feed conduit (122) including an inlet end (126) and an outlet end (128);

a fuel metering mechanism (146) disposed in the fuel feed conduit between the inlet end and the outlet end operable to regulate flow through the fuel feed conduit;

a position feedback sensor (148) operatively connected to the fuel metering mechanism and operable to generate a signal (149) indicative of a position of the fuel metering mechanism; and

a controller (144) operatively connected to the fuel metering mechanism and to the position feedback sensor and operable to control the position of the fuel metering mechanism based on the signal indicative of the position of the fuel metering mechanism and a command (150) for a desired power output of the aircraft engine to achieve the desired power output.

Clause 2. The fuel control system as recited in clause 1, further comprising a fuel pressure sensor (154) operatively connected to the fuel feed conduit and operable to generate a signal (155) indicative of a fuel pressure in the fuel feed conduit, the controller being operatively connected to the fuel pressure sensor and operable to receive the signal from the fuel pressure sensor, wherein the controller is operable to control the position of the fuel metering mechanism based on the signal indicative of the fuel pressure in the fuel feed conduit.

Clause 3. The fuel control system as recited in clause 2, further comprising a temperature sensor (164) operatively connected to the fuel feed conduit and operable to generate a signal (165) indicative of a fuel temperature in the fuel feed conduit, wherein the controller is operable to control the position of the fuel metering mechanism based on the signal indicative of the fuel temperature in the fuel feed conduit.

Clause 4. The fuel control system as recited in clause 3, wherein the fuel pressure sensor is a first fuel pressure sensor and further comprising:

a second fuel pressure sensor (156) operatively connected to the fuel feed conduit and operable to generate a second signal (157) indicative of a fuel pressure in the fuel feed conduit, the controller being operatively connected to the second fuel pressure sensor and operable to receive the second signal from the second fuel pressure sensor, wherein the controller is operable to control the position of the fuel metering mechanism based on the second signal indicative of the fuel pressure in the fuel feed conduit.

Clause 5. The fuel control system as recited in clause 4, further comprising a third pressure sensor (158) operatively connected to the fuel feed conduit and to a combustor (108) operable to generate a signal (159) indicative of a difference in pressure between the feed conduit and the combustor, wherein the controller is operable to control the position of the fuel metering mechanism based on the signal indicative of the difference in pressure between the fuel feed conduit and the combustor.

Clause 6. The fuel control system as recited in clause 5, wherein the first fuel pressure sensor is disposed in the fuel feed conduit upstream of the fuel metering mechanism, wherein the second pressure sensor is disposed in the fuel feed conduit downstream of the electronic metering valve and upstream of the combustor, and wherein a third pressure sensor is operatively connected to the delta pressure sensor (160) and operable to communicate a pressure of the combustor to the delta pressure sensor.

Clause 7. The fuel control system as recited in clause 6, wherein the delta pressure sensor operatively connects to the fuel feed conduit via a delta pressure sensor line (161) separate from a second pressure sensor input line (162) of the second fuel pressure sensor.

Clause 8. The fuel control system as recited in clause 7, wherein each of the signal indicative of a fuel pressure in the fuel feed conduit, the signal indicative of a fuel temperature in the fuel feed conduit, the second signal indicative of a fuel pressure in the fuel feed conduit, and the signal indicative of the difference in pressure between the fuel feed conduit and the combustor comprise a plurality inputs to a control algorithm executable at least in part by the controller to generate a fuel metering mechanism control signal as an output based on the plurality of inputs, wherein the controller is operable to control the fuel metering mechanism by sending the fuel metering mechanism control signal to the fuel metering mechanism.

Clause 9. The fuel control system as recited in clause 1, further comprising a flow divider assembly (166) fluidly connected to the outlet end of the fuel feed conduit to divide and issue flow from the fuel feed conduit into a first fuel manifold (110) and a second fuel manifold (111), the first and second fuel manifolds being fluidly connected to issue fuel to a respective plurality of fuel nozzles (120).

Clause 10. The fuel control system as recited in clause 9, further comprising a first controlled flow valve (172) disposed in the first fuel manifold, and a second controlled flow valve (174) disposed in the second fuel manifold.

Clause 11. The fuel control system as recited in clause 1, wherein the fuel metering mechanism is or includes at least one metering valve operable to regulate flow through the fuel feed conduit.

Clause 12. The fuel control system as recited in clause 1, further comprising a torque motor driver (152) operatively connected to drive the fuel metering mechanism upon receipt by the torque motor driver of a command signal from the controller to control the position of the fuel metering mechanism.

Clause 13. The fuel control system as recited in clause 1, further comprising:

a gaseous pressure and/or temperature regulated fuel supply (124) fluidly connected to the inlet end of the fuel feed conduit;

a first plurality of gaseous hydrogen fuel nozzles (120) fluidly connected to the outlet end of the fuel feed conduit via a first fuel manifold (110); and

a second plurality of gaseous hydrogen fuel nozzles (120) fluidly connected to the outlet end of the fuel feed conduit via a second fuel manifold (111).

Clause 14. An aircraft engine, comprising:

the fuel system as recited in clause 13;

a combustor (108), wherein the first and second pluralities of fuel nozzles are fluidly connected to the combustor;

a compressor section (102) fluidly connected to an inlet of the combustor; and

a turbine section (116) fluidly connected to an outlet (118) of the combustor, wherein the turbine section is operatively connected to the compressor section and operable to drive the compressor section.

Clause 15. A method (300) for controlling fuel flow in an aircraft engine (100), comprising:

determining (302) an energized status of a controlled flow valve in an fuel manifold;

determining (304) if flow in a fuel feed conduit is sonic;

calculating (308) an effective area of an electronic fuel metering valve using a signal indicative of a position of the electronic metering valve from a position feedback sensor;

calculating (316) a required fuel flow for a desired power output; and

adjusting the position of the electronic fuel metering valve and/or the energized status of the flow valve to achieve the required fuel flow based on the signal indicative of the position of the electronic metering valve and a command for a desired output power to achieve the desired power output.

Clause 16. The method as recited in clause 15, further comprising, if a first controlled flow valve and second controlled flow valve are both de-energized to prevent flow,

controlling (306) a flow rate through the electronic metering valve to achieve zero pounds per hour fuel flow through the electronic metering valve.

Clause 17. The method as recited in clause 15, wherein if the first controlled flow valve is energized to allow flow and the flow through the feed conduit is sonic, then further comprising calculating (308) a sonic flow rate as a function of a first fuel pressure in the fuel feed conduit upstream of the electronic metering valve and a first fuel temperature in the fuel feed conduit upstream of the electronic metering valve,

else, if the flow through the feed conduit is sub-sonic, further comprising calculating a subsonic (318) flow rate as a function of the first fuel pressure, the first fuel temperature, a second fuel pressure in the feed conduit downstream of the electronic metering valve, and a pressure differential between the second fuel pressure and a pressure in a combustor of the aircraft engine.

Clause 18. The method as recited in clause 17, further comprising:

after calculating the supersonic flow rate or subsonic flow rate, checking (310, 320) an energized/de-energized status of the first controlled flow valve and of the second controlled flow valve and determining whether the flow through the fuel feed conduit is sonic repeating the steps of claim 17.

Clause 19. The method as recited in claim 19, further comprising calculating a ratio of the second fuel pressure to the first fuel pressure, and determining the flow in the fuel feed conduit is sonic if the ratio is less than 0.5283 and is subsonic if the ratio is greater than or equal to 0.5283.

Clause 20. An electronic controlled aircraft fuel system (200), comprising:

a gas turbine engine (100) having a compressor section (102), a combustor section (108) in fluid communication with an outlet (114) of the compressor section, and a turbine section (116) in fluid communication with an outlet (118) of the combustor, wherein the turbine section is operatively connected to drive the compressor section, and wherein the combustor includes a plurality of fuel nozzles (120) each fluidly connected via a fuel feed conduit (122) to feed the plurality of fuel nozzles of the combustor with a gaseous fuel supply (124);

means for regulating flow (146) through the fuel feed conduit;

means for generating a signal (148) indicative of a state of the means for regulating; and an electronic engine control (EEC) module (144) operatively connected to the means for regulating and to the means for generating a signal to control the means for regulating based on the signal, wherein the EEC module controls a state of the means for regulating to achieve a desired power output.

What is claimed is:

1. A fuel control system for an aircraft engine, comprising:
a fuel feed conduit including an inlet end and an outlet end;
a fuel metering mechanism disposed in the fuel feed conduit between the inlet end and the outlet end operable to regulate flow through the fuel feed conduit;
a position feedback sensor operatively connected to the fuel metering mechanism and operable to generate a signal indicative of a position of the fuel metering mechanism; and
a controller operatively connected to the fuel metering mechanism and to the position feedback sensor and operable to control the position of the fuel metering mechanism based on the signal indicative of the position of the fuel metering mechanism and a command for a desired power output of the aircraft engine to achieve the desired power output.

2. The fuel control system as recited in claim 1, further comprising a fuel pressure sensor operatively connected to the fuel feed conduit and operable to generate a signal indicative of a fuel pressure in the fuel feed conduit, the controller being operatively connected to the fuel pressure sensor and operable to receive the signal from the fuel pressure sensor, wherein the controller is operable to control the position of the fuel metering mechanism based on the signal indicative of the fuel pressure in the fuel feed conduit.

3. The fuel control system as recited in claim 2, further comprising a temperature sensor operatively connected to the fuel feed conduit and operable to generate a signal indicative of a fuel temperature in the fuel feed conduit, wherein the controller is operable to control the position of the fuel metering mechanism based on the signal indicative of the fuel temperature in the fuel feed conduit.

4. The fuel control system as recited in claim 3, wherein the fuel pressure sensor is a first fuel pressure sensor and further comprising:
a second fuel pressure sensor operatively connected to the fuel feed conduit and operable to generate a second signal indicative of a fuel pressure in the fuel feed conduit, the controller being operatively connected to the second fuel pressure sensor and operable to receive the second signal from the second fuel pressure sensor, wherein the controller is operable to control the position of the fuel metering mechanism based on the second signal indicative of the fuel pressure in the fuel feed conduit.

5. The fuel control system as recited in claim 4, further comprising a delta pressure sensor operatively connected to the fuel feed conduit and to a combustor operable to generate a signal indicative of a difference in pressure between the feed conduit and the combustor, wherein the controller is operable to control the position of the fuel metering mechanism based on the signal indicative of the difference in pressure between the fuel feed conduit and the combustor.

6. The fuel control system as recited in claim 5, wherein the first fuel pressure sensor is disposed in the fuel feed conduit upstream of the fuel metering mechanism, wherein the second pressure sensor is disposed in the fuel feed conduit downstream of the electronic metering valve and upstream of the combustor, and wherein a third pressure sensor is operatively connected to the delta pressure sensor and operable to communicate a pressure of the combustor to the delta pressure sensor.

7. The fuel control system as recited in claim 6, wherein the delta pressure sensor operatively connects to the fuel feed conduit via a delta pressure sensor line separate from a second pressure sensor input line of the second fuel pressure sensor.

8. The fuel control system as recited in claim 7, wherein each of the signal indicative of a fuel pressure in the fuel feed conduit, the signal indicative of a fuel temperature in the fuel feed conduit, the second signal indicative of a fuel pressure in the fuel feed conduit, and the signal indicative of the difference in pressure between the fuel feed conduit and the combustor comprise a plurality inputs to a control algorithm executable at least in part by the controller to generate a fuel metering mechanism control signal as an output based on the plurality of inputs, wherein the controller is operable to control the fuel metering mechanism by sending the fuel metering mechanism control signal to the fuel metering mechanism.

9. The fuel control system as recited in claim 1, further comprising a flow divider assembly fluidly connected to the outlet end of the fuel feed conduit to divide and issue flow from the fuel feed conduit into a first fuel manifold and a second fuel manifold, the first and second fuel manifolds being fluidly connected to issue fuel to a respective plurality of fuel nozzles.

10. The fuel control system as recited in claim 9, further comprising a first controlled flow valve disposed in the first fuel manifold, and a second controlled flow valve disposed in the second fuel manifold.

11. The fuel control system as recited in claim 1, wherein the fuel metering mechanism is or includes at least one metering valve operable to regulate flow through the fuel feed conduit.

12. The fuel control system as recited in claim 1, further comprising a torque motor driver operatively connected to drive the fuel metering mechanism upon receipt by the torque motor driver of a command signal from the controller to control the position of the fuel metering mechanism.

13. The fuel control system as recited in claim 1, further comprising:
a gaseous pressure and/or temperature regulated fuel supply fluidly connected to the inlet end of the fuel feed conduit;
a first plurality of gaseous hydrogen fuel nozzles fluidly connected to the outlet end of the fuel feed conduit via a first fuel manifold; and
a second plurality of gaseous hydrogen fuel nozzles fluidly connected to the outlet end of the fuel feed conduit via a second fuel manifold.

14. An aircraft engine, comprising:
the fuel system as recited in claim 13;
a combustor, wherein the first and second pluralities of fuel nozzles are fluidly connected to the combustor;
a compressor section fluidly connected to an inlet of the combustor; and
a turbine section fluidly connected to an outlet of the combustor, wherein the turbine section is operatively connected to the compressor section and operable to drive the compressor section.

15. A method for controlling fuel flow in an aircraft engine, comprising:
determining an energized status of a controlled flow valve in an fuel manifold;
determining if flow in a fuel feed conduit is sonic;
calculating an effective area of an electronic fuel metering valve using a signal indicative of a position of the electronic metering valve from a position feedback sensor;
calculating a required fuel flow for a desired power output; and
adjusting the position of the electronic fuel metering valve and/or the energized status of the flow valve to achieve the required fuel flow based on the signal indicative of the position of the electronic metering valve and a command for a desired output power to achieve the desired power output.

16. The method as recited in claim 15, further comprising, if a first controlled flow valve and second controlled flow valve are both de-energized to prevent flow,
controlling a flow rate through the electronic metering valve to achieve zero pounds per hour fuel flow through the electronic metering valve.

17. The method as recited in claim 15, wherein if the first controlled flow valve is energized to allow flow and the flow through the feed conduit is sonic, then further comprising calculating a sonic flow rate as a function of a first fuel pressure in the fuel feed conduit upstream of the electronic metering valve and a first fuel temperature in the fuel feed conduit upstream of the electronic metering valve,
else, if the flow through the feed conduit is sub-sonic, further comprising calculating a subsonic flow rate as a function of the first fuel pressure, the first fuel temperature, a second fuel pressure in the feed conduit downstream of the electronic metering valve, and a pressure differential between the second fuel pressure and a pressure in a combustor of the aircraft engine.

18. The method as recited in claim 17, further comprising:
after calculating the supersonic flow rate or subsonic flow rate, checking an energized/de-energized status of the first controlled flow valve and of the second controlled flow valve and determining whether the flow through the fuel feed conduit is sonic repeating the steps of claim 17.

19. The method as recited in claim 19, further comprising calculating a ratio of the second fuel pressure to the first fuel pressure, and determining the flow in the fuel feed conduit is sonic if the ratio is less than 0.5283 and is subsonic if the ratio is greater than or equal to 0.5283.

20. An electronic controlled aircraft fuel system, comprising:
a gas turbine engine having a compressor section, a combustor section in fluid communication with an outlet of the compressor section, and a turbine section in fluid communication with an outlet of the combustor, wherein the turbine section is operatively connected to drive the compressor section, and wherein the combustor includes a plurality of fuel nozzles each fluidly connected via a fuel feed conduit to feed the plurality of fuel nozzles of the combustor with a gaseous fuel supply;
means for regulating flow through the fuel feed conduit;
means for generating a signal indicative of a state of the means for regulating; and an electronic engine control (EEC) module operatively connected to the means for regulating and to the means for generating a signal to control the means for regulating based on the signal, wherein the EEC module controls a state of the means for regulating to achieve a desired power output.
